(19) United States
(12) Patent Application Publication
(10) Pub. No.: US 2022/0292052 A1
(43) Pub. Date: Sep. 15, 2022

(54) METHOD AND SYSTEM FOR ENABLING USERS TO CROSS-REFERENCE DIFFERENT SOURCES OF QUALITY OF TELECOM EXPERIENCE

(71) Applicant: MOZARK PTE. LTD., (US)

(72) Inventors: Thierry MONCORGER, Marolles en Brie (FR); Julie MONCORGER, Montsauche-les-Settons (FR); Francois SOM, Noisy-Le-Grand (FR); Chandrasekar RAMAMOORTHY, Mumbai (IN); Kartik RAJA, Mumbai (IN)

(73) Assignee: MOZARK PTE. LTD.

(21) Appl. No.: 17/199,663

(22) Filed: Mar. 12, 2021

(51) Int. Cl. G06F 16/11; G06F 16/29; H04B 17/309; H04B 17/391

(52) U.S. Cl. CPC G06F 16/116; G06F 16/29; H04B 17/309; H04B 17/391

(57) ABSTRACT

The present disclosure provides a method and system for enabling a plurality of users to cross-reference different sources of quality of telecom experience using a QoE database management system. The QoE database management system receives a plurality of source files from one or more QoE sources. In addition, the QoE database management system converts the plurality of source files received from the one or more QoE sources into one or more compatible formats. Further, the QoE database management system maps each of the plurality of source files with at least one of a set of data based on a category in real-time. Furthermore, the QoE database management system standardizes at least one of a plurality of fields of each of the plurality of source files in real-time.

### TECHNICAL FIELD

The present invention relates to the technical field of quality of experience platforms, and in particular, relates to a method and system for enabling users to cross-reference different sources of quality of telecom experience.

### INTRODUCTION

Nowadays, determination to understand customer experience has been stimulated by intense competition in telecommunications industry. As the telecommunications industry saturates, thereby intensifying competition, service providers endeavor to increase customer retention. Generally, customer churns, which is led by customer dissatisfaction, is disadvantageous for the service providers. The customer churn causes not only decrease in profit, but also the loss of opportunities for existing customers to suggest corresponding service provider to other users. Moreover, attracting new customer costs more than retaining the existing customers. For these reasons, enhancing the customer experience has been a critical factor for the telecommunications industry. Hence, Quality of experience (QoE) has been of intense interests for the telecommunications industry as the QoE provides holistic view of the customer experience. The service providers manage customer relationships using various types of key performance indicators (KPIs) to evaluate overall customer-perceived QoE. However, present QoE platforms are inefficient to operate for different formats gathered from multiple data sources. In addition, the QoE platforms are ineffective for data crossing.

### SUMMARY

In a first example, a computer-implemented method is provided. The computer-implemented method enables a plurality of users to cross-reference different sources of quality of telecom experience. The computer-implemented method includes a first step to receive a plurality of source files from one or more QoE sources at a QoE database management system. The plurality of source files is in one or more formats. In addition, the computer-implemented method includes a second step to convert the plurality of source files received from the one or more QoE sources into one or more compatible formats. The plurality of source files is converted into the one or more compatible formats in real-time. Further, the computer-implemented method includes a third step to maps each of the plurality of source files with at least one of a set of data based on a category. Each of the plurality of source files is mapped with the at least one of the set of data in real-time. Furthermore, the computer-implemented method includes a fourth step to standardize at least one of a plurality of fields of each of the plurality of source files. The at least one of the plurality of fields is standardized to converge on a QoE database in real-time.

In an embodiment of the present disclosure, the one or more QoE sources include at least one of one or more telecom sources and one or more generic sources.

In an embodiment of the present disclosure, the one or more compatible formats include at least one of one or more text file formats, one or more spreadsheet file formats and one or more geographic file formats.

In an embodiment of the present disclosure, the category includes at least one of measurement, antennas and point of interest.

In an embodiment of the present disclosure, the set of data includes date, latitude, longitude, country, type of connection, a telecom operator, measures protocol and a plurality of key performance indicators for each protocol.

In an embodiment of the present disclosure, the computer-implemented method enables the plurality of users to specify a cell of at least one of the plurality of source files where corresponding data of the set of data is stored. In addition, the plurality of users specifies the cell of the at least one of the plurality of source files in real-time.

In an embodiment of the present disclosure, the computer-implemented method integrates content of each of the plurality of source files based on similarity in nature to same column of a table of the QoE database.

In an embodiment of the present disclosure, the computer-implemented method compares a value provided by the plurality of users to at least one of a plurality of values. In addition, the plurality of values includes international code of a telecom operator, internal code at the QoE database management system and commercial name of the telecom operator.

In an embodiment of the present disclosure, the plurality of fields includes the country, the telecom operator, the type of connection, technology, device model, typical rental, measurement state and operating system.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method to enable the plurality of users to cross-reference different sources of the quality of telecom experience. The method includes a first step to receive the plurality of source files from the one or more QoE sources. The plurality of source files is in the one or more formats. In addition, the method includes a second step to convert the plurality of source files received from the one or more QoE sources into the one or more compatible formats. The plurality of source files is converted into the one or more compatible formats in real-time. Further, the method includes a third step to maps each of the plurality of source files with the at least one of the set of data based on the category. Each of the plurality of source files is mapped with the at least one of the set of data in real-time. Furthermore, the method includes a fourth step to standardize the at least one of the plurality of fields of each of the plurality of source files. The at least one of the plurality of fields is standardized to converge on the QoE database in real-time.

In an embodiment of the present disclosure, the one or more QoE sources include at least the one of one or more telecom sources and the one or more generic sources.

In an embodiment of the present disclosure, the one or more compatible formats include at least one of the one or more text file formats, the one or more spreadsheet file formats and the one or more geographic file formats.

In an embodiment of the present disclosure, the category includes at least one of the measurement, the antennas and the point of interest.

In an embodiment of the present disclosure, the set of data includes date, latitude, longitude, the country, type of connection, the telecom operator, the measures protocol and the plurality of key performance indicators for each protocol.

In an embodiment of the present disclosure, the QoE database management system enables the plurality of users to specify the cell of at least one of the plurality of source files where corresponding data of the set of data is stored. In addition, the plurality of users specifies the cell of the at least one of the plurality of source files in real-time.

In an embodiment of the present disclosure, the QoE database management system integrates the content of each of the plurality of source files based on similarity in nature to same column of the table of the QoE database.

In an embodiment of the present disclosure, the QoE database management system compares the value provided by the plurality of users to the at least one of the plurality of values. In addition, the plurality of values includes international code of the telecom operator, internal code at the QoE database management system and commercial name of the telecom operator.

In an embodiment of the present disclosure, the plurality of fields includes the country, the telecom operator, the type of connection, technology, device model, typical rental, measurement state and operating system.

In a third example, a non-transitory computer-readable storage medium is provided. The non-transitory computer-readable storage medium encodes computer executable instructions that, when executed by at least one processor, performs a method to enable the plurality of users to cross-reference different sources of the quality of telecom experience. The method includes a first step to receive the plurality of source files from the one or more QoE sources. The plurality of source files is in the one or more formats. In addition, the method includes a second step to convert the plurality of source files received from the one or more QoE sources into the one or more compatible formats. The plurality of source files is converted into the one or more compatible formats in real-time. Further, the method includes a third step to maps each of the plurality of source files with the at least one of the set of data based on the category. Each of the plurality of source files is mapped with the at least one of the set of data in real-time. Furthermore, the method includes a fourth step to standardize the at least one of the plurality of fields of each of the plurality of source files. The at least one of the plurality of fields is standardized to converge on the QoE database in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment to enable a plurality of users to cross-reference different sources of quality of telecom experience, in accordance with various embodiments of the present disclosure;

FIG. 2 illustrates a flowchart to enable the plurality of users to cross-reference different sources of the quality of telecom experience, in accordance with various embodiments of the present disclosure; and

FIG. 3 illustrates a block diagram of a computing device, in accordance with various embodiments of the present disclosure.

There may be additional structures described in the description that are not depicted in the drawings, and the absence of such depictions should not be considered as an omission of such design from the specification.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

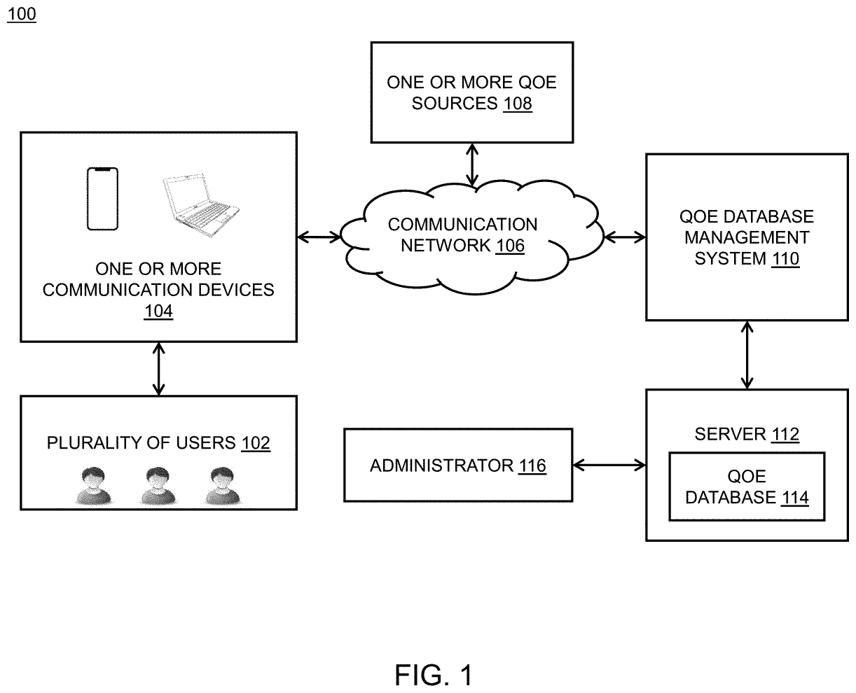

FIG. 1 illustrates an interactive computing environment 100 to enable a plurality of users 102 to cross-reference different sources of quality of telecom experience, in accordance with various embodiments of the present disclosure. The interactive computing environment 100 includes one or more communication devices 104, a communication network 106 and one or more QoE sources 108. In addition, the interactive computing environment 100 includes a QoE database management system 110, a server 112, a QoE database 114 and an administrator 116. The above stated elements of the interactive computing environment 100 operate coherently and synchronously to enable the plurality of users 102 to cross-reference different sources of the quality of telecom experience.

The plurality of users 102 may be any person or individual accessing the one or more communication devices 104. In an embodiment of the present disclosure, each of the plurality of users 102 is an owner of the one or more communication devices 104. In another embodiment of the present disclosure, each of the plurality of users 102 is not the owner of the one or more communication devices 104. In an embodiment of the present disclosure, the plurality of users 102 accesses the one or more communication devices 104 at home. In another embodiment of the present disclosure, the plurality of users 102 accesses the one or more communication devices 104 at a cafe. In yet another embodiment of the present disclosure, the plurality of users 102 accesses the one or more communication devices 104 in an office. In an example, a user U1 accesses a smartphone S1 while sitting in a living room. In another example, a user U2 accesses a laptop L1 while travelling from one place to another. In yet another example, a user U3 accesses a desktop computer D1 while working in the office.

The plurality of users 102 corresponds to any number of person or individual associated with the QoE database management system 110. The QoE database management system 110 accesses the quality of telecom experience for each of the plurality of users 102 on the communication network 106 of the one or more communication devices 104. In an example, a user U1 watches anime on a platform P1 through a communication device D1 (let's say a smartphone) using a communication network N1. In another example, a user U2 performs financial transaction on a platform P2 through a communication device D2 (let's say a desktop computer) using a communication network N2. In yet another example, a user U3 performs documentation on a platform P3 through a communication device D3 (let's say a laptop) using a communication network N3.

The interactive computing environment 100 includes the plurality of users 102 who is any person present at any of a plurality of geographical locations and accessing the one or more communication devices 104. The plurality of users 102 is any legal person or natural person who access the one or more communication devices 104 and need an IP based network for accessing one or more platforms for a plurality of contents. In addition, the plurality of users 102 is an individual or person who accesses the one or more platforms on the one or more communication devices 104. Further, the one or more communication devices 104 are present in the plurality of geographical locations with any of a network condition of the communication network 106. Furthermore, the network condition of the communication network 106 governs the quality of telecom experience. Moreover, the network condition of the communication network 106 includes poor, moderate, good, excellent and the like.

In an embodiment of the present disclosure, the plurality of contents include but may not be limited to a plurality of OTT media contents, a plurality of products, a plurality of financial services, and one or more social media contents. In another embodiment of the present disclosure, the plurality of contents include but may not be limited to a plurality of health services, a plurality of educational services, a plurality of real estate services, and a plurality of travel services. However, the plurality of contents is not limited to the above-mentioned contents.

In an embodiment of the present disclosure, the one or more platforms correspond to android operating system compatible platforms. In another embodiment of the present disclosure, the one or more platforms correspond to windows operating system compatible platforms. In yet another embodiment of the present disclosure, the one or more platforms correspond to iPhone operating system compatible platforms. In yet another embodiment of the present disclosure, the one or more platforms correspond to mac operating system compatible platforms. In yet another embodiment of the present disclosure, the one or more platforms correspond to webpages. However, the one or more platforms are not limited to the above-mentioned online platforms.

The one or more communication devices 104 enable the plurality of users 102 to access the one or more platforms over the communication network 106. The one or more communication devices 104 are internet-enabled devices to allow the plurality of users 102 to access the one or more platforms. In addition, the one or more communication devices 104 facilitate access to the QoE database management system 110. In an embodiment of the present disclosure, each of the one or more communication devices 104 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 104 is a fixed communication device. The fixed communication device includes but may not be limited to a desktop, a workstation, a smart TV and a mainframe computer. In an embodiment of the present disclosure, the one or more communication devices 104 are currently in the switched-on state. The one or more communication devices 104 are any type of devices having an active internet. In addition, each of the plurality of users 102 accesses corresponding communication device of the one or more communication devices 104 in real-time.

In an embodiment of the present disclosure, the one or more communication devices 104 perform computing operations based on a suitable operating system installed inside the one or more communication devices 104. In general, the operating system is system software that manages computer hardware and software resources and provides common services for computer programs. In addition, the operating system acts as an interface for software installed inside the one or more communication devices 104 to interact with hardware components of the one or more communication devices 104. In an embodiment of the present disclosure, each of the one or more communication devices 104 perform computing operations based on any suitable operating system designed for the portable communication device. In an example, the operating system installed inside the one or more communication devices 104 is a mobile operating system. Further, the mobile operating system includes but may not be limited to windows operating system, android operating system, iOS operating system, and Sailfish. However, the operating system is not limited to above mentioned operating systems. In an embodiment of the present disclosure, the one or more communication devices 104 operate on any version of particular operating system corresponding to above mentioned operating systems.

In another embodiment of the present disclosure, the one or more communication devices 104 perform computing operations based on any suitable operating system designed for fixed communication device. In an example, the operating system installed inside the one or more communication devices 104 is windows. In another example, the operating system installed inside the one or more communication devices 104 is Mac. In yet another example, the operating system installed inside the one or more communication devices 104 is Linux based operating system. In yet another example, the operating system installed inside the one or more communication devices 104 is Chrome OS. In yet another example, the operating system installed inside the one or more communication devices 104 may be one of UNIX, Kali Linux, and the like. However, the operating system is not limited to above mentioned operating systems.

In an embodiment of the present disclosure, the one or more communication devices 104 operate on any version of windows operating system. In another embodiment of the present disclosure, the one or more communication devices 104 operate on any version of Mac operating system. In yet another embodiment of the present disclosure, the one or more communication devices 104 operate on any version of Linux operating system. In yet another embodiment of the present disclosure, the one or more communication devices 104 operate on any version of Chrome OS. In yet another embodiment of the present disclosure, the one or more communication devices 104 operate on any version of particular operating system corresponding to above mentioned operating systems.

The one or more communication devices 104 enable the plurality of users 102 to access the QoE database management system 110. The one or more communication devices 104 are internet-enabled devices that allow the plurality of users 102 to access the QoE database management system 110 using the communication network 106. In an embodiment of the present disclosure, the QoE database management system 110 is installed on the one or more communication devices 104. The QoE database management system 110 allows the plurality of users 102 to cross-reference the one or more QoE sources 108 of the quality of telecom experience. In another embodiment of the present disclosure, the QoE database management system 110 runs on a plurality of web browsers installed on the one or more communication devices 104. In an example, the plurality of web browsers include but may not be limited to Opera, Mozilla Firefox, Google Chrome, Internet Explorer, Microsoft Edge, Safari and UC Browser. Further, the plurality of web browsers installed on the one or more communication devices 104 runs on any version of the respective web browser of the above mentioned web browsers. In an embodiment of the present disclosure, the plurality of users 102 installs the QoE database management system 110 on the one or more communication devices 104. In another embodiment of the present disclosure, the plurality of users 102 accesses the QoE database management system 110 on the plurality of web browsers installed on the one or more communication devices 104.

In an example, a user U1 connects with the interactive computing environment 100 through a communication device D1 (let's say a smartphone) to run the QoE database management system 110. In another example, a user U2 connects with the computing environment 100 through a communication device D2 (let's say a desktop computer) at home to access the QoE database management system 110. In ye another example, the user U3 connects with the computing environment 100 with a communication device D3 (let's say a tablet) while travelling to access the QoE database management system 110.

Each of the one or more communication devices 104 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processors read data from various entities such as memory or I/O components. The one or more processors execute the one or more instructions which are stored in the memory. The one or more processors provide execution method for one or more instructions provided by the QoE database management system 110.

The one or more platforms correspond to program designed for the plurality of users 102 to perform the plurality of activities. The plurality of activities includes streaming, calendaring, scheduling, banking, trading, blogging, mailing, accounting, editing, designing, database management, word processing, simulation, and the like. The plurality of users 102 performs the plurality of activities on the one or more platforms through the one or more communication devices 104. In an example, the one or more platforms include documentation platforms, data management platforms, financial platforms, and entertainment platforms. In another example, the one or more platforms include educational platforms, enterprise platforms, simulation platforms, media development platforms, and the like.

The interactive computing environment 100 includes the communication network 106. The one or more communication devices 104 are connected to the communication network 106. The communication network 106 is provided by a telecom operator. The communication network 106 provides a medium for the plurality of users 102 accessing the one or more communication devices 104 to connect with the QoE database management system 110. In an embodiment of the present disclosure, the communication network 106 is an internet connection. In another embodiment of the present disclosure, the communication network 106 is a wireless mobile network. In yet another embodiment of the present disclosure, the communication network 106 is a wired network with a finite bandwidth. In yet another embodiment of the present disclosure, the communication network 106 is a combination of the wireless and the wired network for the optimum throughput of data transmission. In yet another embodiment of the present disclosure, the communication network 106 is an optical fiber high bandwidth network that enables a high data rate with negligible connection drops. The communication network 106 includes a set of channels. Each channel of the set of channels supports a finite bandwidth. Moreover, the finite bandwidth of each channel of the set of channels is based on capacity of the communication network 106. The communication network 106 connects the one or more communication devices 104 to the QoE database management system 110 using a plurality of methods. The plurality of methods used to provide network connectivity to the one or more communication devices 104 includes 2G, 3G, 4G, 5G, Wifi and the like.

The communication network 106 has a plurality of factors that governs the quality of telecom experience of each of the plurality of users 102. In addition, the plurality of factors includes signal strength, quality, transmission power, handover latency, Inter Radio Access Technologies, downlink throughput, uplink throughput, latency, and packet loss. Further, the plurality of factors includes jitter, web latency of websites, video latency, and the like.

The interactive computing environment 100 includes the one or more QoE sources 108. The one or more QoE sources 108 include at least one of one or more telecom sources and one or more generic sources. In addition, the one or more QoE sources 108 provide a plurality of parameters associated with the quality of telecom experience of each of the users 102. Further, the plurality of parameters include but may not be limited to telecom speed measurement, radio measurement, cell coverage created by the telecom operator and repositories of cellular antennas of the telecom operator. Furthermore, the one or more telecom sources provide QoE/QoS measurement tool files, operator coverage shapefile, information associated with telecom sites of the telecom operator and the like. Moreover, the one or more generic sources provide geographical data and customer data. In an example, the one or more QoE sources 108 include 5Gmark, Ookla, nPerf, Nemo, Accuver, OpenSignal, Tems, Aquamark, Headspin and the like.

The interactive computing environment 100 includes the QoE database management system 110. The QoE database management system 110 receives a plurality of source files from the one or more QoE sources 108. In addition, the plurality of source files is in one or more formats. Further, the one or more QoE sources 108 include at least one of the one or more telecom sources and the one or more generic sources. Furthermore, the one or more formats include at least one of spreadsheet based formats, video formats, tabulated data formats, text file formats, geolocation based formats and the like.

In an example, the QoE database management system 110 receives the QoE/QoS measurement tool files from the one or more telecom sources (Let's say 5Gmark) for a user U1 accessing the internet connection of a telecom operator O1 through the iOS-based smartphone. In another example, the QoE database management system 110 receives the QoE/QoS measurement tool files from the one or more telecom sources (Let's say 5Gmark) for a user U2 accessing the wireless mobile network of a telecom operator O2 through the android-based smartphone. In yet another example, the QoE database management system 110 receives the QoE/QoS measurement tool files from the one or more telecom sources (Let's say 5Gmark) for a user U3 accessing the wired network with a finite bandwidth of a telecom operator O3 through the workstation. In yet another example, the QoE database management system 110 receives the QoE/QoS measurement tool files from the one or more telecom sources (Let's say 5Gmark) for a user U4 accessing the optical fiber high bandwidth network of a telecom operator O4 through the laptop.

In yet another example, the QoE database management system 110 receives the QoE/QoS measurement tool files from the one or more telecom sources (Let's say Ookla) for a user U5 accessing the internet connection of a telecom operator O5 through the smartwatch. In yet another example, the QoE database management system 110 receives the QoE/QoS measurement tool files from the one or more telecom sources (Let's say Ookla) for a user U6 accessing the wireless mobile network of a telecom operator O6 through the windows-based smartphone. In yet another example, the QoE database management system 110 receives the QoE/QoS measurement tool files from the one or more telecom sources (Let's say Ookla) for a user U7 accessing the wired network with a finite bandwidth of a telecom operator O7 through the laptop. In yet another example, the QoE database management system 110 receives the QoE/QoS measurement tool files from the one or more telecom sources (Let's say Ookla) for a user U8 accessing the optical fiber high bandwidth network of a telecom operator O8 through the tablet.

In yet another example, the QoE database management system 110 receives the operator coverage shapefile from a telecom operator O9 for a user U9 accessing the internet connection of the telecom operator O9 through the iOS-based smartphone. In yet another example, the QoE database management system 110 receives the operator coverage shapefile from a telecom operator O10 for a user U10 accessing the wireless mobile network of the telecom operator O10 through the android-based smartphone. In yet another example, the QoE database management system 110 receives the operator coverage shapefile from a telecom operator O11 for a user U11 accessing the wired network with a finite bandwidth of the telecom operator O11 through the workstation. In yet another example, the QoE database management system 110 receives the operator coverage shapefile from a telecom operator O12 for a user U12 accessing the optical fiber high bandwidth network of the telecom operator O12 through the laptop.

In yet another example, the QoE database management system 110 receives the operator coverage shapefile from a telecom operator O13 for a user U13 accessing the internet connection of the telecom operator O13 through the smartwatch. In yet another example, the QoE database management system 110 receives the operator coverage shapefile from a telecom operator O14 for a user U14 accessing the wireless mobile network of the telecom operator O14 through the windows-based smartphone. In yet another example, the QoE database management system 110 receives the operator coverage shapefile from a telecom operator O15 for a user U15 accessing the wired network with a finite bandwidth of the telecom operator O15 through the tablet.

In yet another example, the QoE database management system 110 receives the radio measurement data from the one or more telecom sources (Let's say Accuver) for a user U16 accessing the internet connection of the telecom operator O16 through the laptop. In yet another example, the QoE database management system 110 receives the radio measurement data from the one or more telecom sources (Let's say Accuver) for a user U17 accessing the wireless mobile network of the telecom operator O17 through the android-based smartphone. In yet another example, the QoE database management system 110 receives the radio measurement data from the one or more telecom sources (Let's say Accuver) for a user U18 accessing the wired network with the finite bandwidth of the telecom operator O18 through the workstation.

In yet another example, the QoE database management system 110 receives the radio measurement data from the one or more telecom sources (Let's say Tems) for a user U19 accessing the internet connection of the telecom operator O19 through the tablet. In yet another example, the QoE database management system 110 receives the radio measurement data from the one or more telecom sources (Let's say Tems) for a user U20 accessing the wireless mobile network of the telecom operator O20 through the iOS-based smartphone. In yet another example, the QoE database management system 110 receives the radio measurement data from the one or more telecom sources (Let's say Tems) for a user U21 accessing the wired network with the finite bandwidth of the telecom operator O21 through the desktop.

The QoE database management system 110 converts the plurality of source files received from the one or more QoE sources 108 into one or more compatible formats. In addition, the plurality of source files is converted into the one or more compatible formats in real-time. Further, the one or more compatible formats include at least one of one or more text file formats, one or more spreadsheet file formats and one or more geographic file formats. The QoE database management system 110 is configured to automatically detect the one or more formats of the plurality of source files to convert the plurality of source files into the one or more compatible formats. The one or more text file formats include text file, comma-separated values and the like. The one or more spreadsheet file formats include open extensible markup language worksheet, excel worksheet and the like. The one or more geographic file formats include shapefile format, keyhole markup language format and the like.

In an example, the QoE database management system 110 converts the QoE/QoS measurement tool files into the text file format for a user U1 accessing the internet connection of a telecom operator O1 through the iOS-based smartphone. In another example, the QoE database management system 110 converts the QoE/QoS measurement tool files into the text file format for a user U2 accessing the wireless mobile network of a telecom operator O2 through the android-based smartphone. In yet another example, the QoE database management system 110 converts the QoE/QoS measurement tool files into the text file format for a user U3 accessing the wired network with a finite bandwidth of a telecom operator O3 through the workstation. In yet another example, the QoE database management system 110 converts the QoE/QoS measurement tool files into the text file format for a user U4 accessing the optical fiber high bandwidth network of a telecom operator O4 through the laptop.

In yet another example, the QoE database management system 110 converts the operator coverage shapefile into the keyhole markup language format for a user U5 accessing the internet connection of a telecom operator O5 through the iOS-based smartphone. In yet another example, the QoE database management system 110 converts the operator coverage shapefile into the keyhole markup language format for a user U6 accessing the wireless mobile network of a telecom operator O6 through the android-based smartphone. In yet another example, the QoE database management system 110 converts the operator coverage shapefile into the keyhole markup language format for a user U7 accessing the wired network with a finite bandwidth of a telecom operator O7 through the workstation. In yet another example, the QoE database management system 110 converts the operator coverage shapefile into the keyhole markup language format for a user U8 accessing the optical fiber high bandwidth network of a telecom operator O8 through the laptop.

In yet another example, the QoE database management system 110 converts the radio measurement data into the excel worksheet format received from the one or more telecom sources (Let's say Keysight) for a user U9 accessing the internet connection of a telecom operator O9 through the laptop. In yet another example, the QoE database management system 110 converts the radio measurement data into the excel worksheet format received from the one or more telecom sources (Let's say Keysight) for a user U10 accessing the wireless mobile network of a telecom operator O10 through the android-based smartphone. In yet another example, the QoE database management system 110 converts the radio measurement data into the excel worksheet format received from the one or more telecom sources (Let's say Keysight) for a user U11 accessing the wired network with the finite bandwidth of a telecom operator O11 through the workstation.

The QoE database management system 110 maps each of the plurality of source files with at least one of a set of data based on a category. In addition, each of the plurality of source files is mapped with the at least one of the set of data in real-time. Further, the category includes at least one of measurement, antennas, point of interest and the like. Furthermore, the set of data includes date, latitude, longitude, country, type of connection, the telecom operator, measures protocol and a plurality of key performance indicators for each protocol. The plurality of key performance indicators includes performance of each of the communication network 106, churn rate of the communication network 106, network drop for the communication network 106 and the like. In an example, the point of interest includes tourist sites, town halls, hospitals, schools, executive buildings and the like.

In an example, the QoE database management system 110 maps the QoE/QoS measurement tool files with the latitude based on the measurement for a user U1 accessing the internet connection of a telecom operator O1 through the iOS-based smartphone. In another example, the QoE database management system 110 maps the QoE/QoS measurement tool files with the longitude based on the measurement for a user U2 accessing the wireless mobile network of a telecom operator O2 through the android-based smartphone. In yet another example, the QoE database management system 110 maps the QoE/QoS measurement tool files with the country based on the measurement for a user U3 accessing the wired network with a finite bandwidth of a telecom operator O3 through the workstation. In yet another example, the QoE database management system 110 maps the QoE/QoS measurement tool files with a telecom operator O4 based on the measurement for a user U4 accessing the optical fiber high bandwidth network of the telecom operator O4 through the laptop.

In yet another example, the QoE database management system 110 maps the operator coverage shapefile with the performance of the communication network 106 based on the antennas for a user U5 accessing the internet connection of a telecom operator O5 through the iOS-based smartphone. In yet another example, the QoE database management system 110 maps the operator coverage shapefile with the churn rate based on the antennas for a user U6 accessing the wireless mobile network of a telecom operator O6 through the android-based smartphone. In yet another example, the QoE database management system 110 maps the operator coverage shapefile with the network drop based on the antennas for a user U7 accessing the wired network with a finite bandwidth of a telecom operator O7 through the workstation. In yet another example, the QoE database management system 110 maps the operator coverage shapefile with the country based on the antennas for a user U8 accessing the optical fiber high bandwidth network of a telecom operator O8 through the laptop.

The QoE database management system 110 enables the plurality of users 102 to specify a cell of at least one of the plurality of source files where corresponding data of the set of data is stored. In addition, the plurality of users specifies the cell of the at least one of the plurality of source files in real-time. The cell is associated with at least one of a column and a row of the at least one of the plurality of source files. The QoE database management system 110 integrates content of each of the plurality of source files based on similarity in nature to same column of a table of the QoE database 114.

The QoE database management system 110 standardizes at least one of a plurality of fields of each of the plurality of source files. In addition, the at least one of the plurality of fields of the plurality of source files is standardized to converge on the QoE database 114 in real-time. Further, the plurality of fields includes the country, the telecom operator, the type of connection, technology, device model, typical rental, measurement state and operating system.

The QoE database management system 110 compares a value provided by the plurality of users 102 to at least one of a plurality of values of the plurality of fields. In addition, the plurality of values includes international code of the telecom operator, internal code at the QoE database management system 110 and commercial name of the telecom operator. In an embodiment of the present disclosure, the QoE database management system 110 records the set of data if the telecom operator is discovered by comparing the value with the at least one of the plurality of values. In another embodiment of the present disclosure, the QoE database management system 110 searches for synonyms if the telecom operator is not discovered by comparing the value with the at least one of the plurality of values. In yet another embodiment of the present disclosure, the QoE database management system 110 request the plurality of users 102 to specify name of the telecom operator through a drop-down list of possibilities if the telecom operator is not discovered by comparing the value with the at least one of the plurality of values. The synonyms allow the QoE database management system 110 to learn through the plurality of users 102. Moreover, the synonyms enable the QoE database management system 110 to recognize the telecom operator and associate the telecom operator with accurate international code.

The QoE database management system 110 enriches the geographical data through association of at least one of a city, a region and a square of a pre-defined length. In an embodiment of the present disclosure, the pre-defined length of the square is about 50 meters. In another embodiment of the present disclosure, the pre-defined length of the square varies in a range of 50 meters to 50 kilometers. In yet another embodiment of the present disclosure, the pre-defined length of the square may vary. The association of the geographical data with the square of the pre-defined length enables the integration of the set of data contained in same square.

The interactive computing environment 100 includes the server 112 and the QoE database 114. The QoE database management system 110 is associated with the server 112. In general, server is a computer program or device that provides functionality for other programs or devices. The server 112 provides various functionalities, such as sharing data or resources among multiple clients, or performing computation for a client. However, those skilled in the art would appreciate that the QoE database management system 110 is connected to more number of servers. Furthermore, it may be noted that the server 112 includes the QoE database 114. However, those skilled in the art would appreciate that more number of the servers include more numbers of database.

In an embodiment of the present disclosure, the QoE database management system 110 is located in the server 112. In another embodiment of the present disclosure, the QoE database management system 110 is connected with the server 112. In yet another embodiment of the present disclosure, the QoE database management system 110 is a part of the server 112. The server 112 handles each operation and task performed by the QoE database management system 110. The server 112 stores one or more instructions for performing the various operations of the QoE database management system 110. The server 112 is located remotely from the QoE database management system 110. The server 112 is associated with the administrator 116. In general, administrator manages the different components in system. The administrator 116 coordinates the activities of the components involved in the QoE database management system 110. The administrator 116 is any person or individual who monitors the working of the QoE database management system 110 and the server 112 in real-time. The administrator 116 monitors the working of the QoE database management system 110 and the server 112 through a communication device. The communication device includes the laptop, the desktop computer, the tablet, a personal digital assistant and the like.

The QoE database 114 stores different sets of information associated with various components of the QoE database management system 110. In general, database is used to hold general information and specialized data, such as the plurality of source and the set of data, and the like. The QoE database 114 stores the information of the one or more communication devices 104, the communication network 106, and the like. The QoE database 114 organizes the data using model such as relational models or hierarchical models. Further, the QoE database 114 stores data provided by the administrator 116.

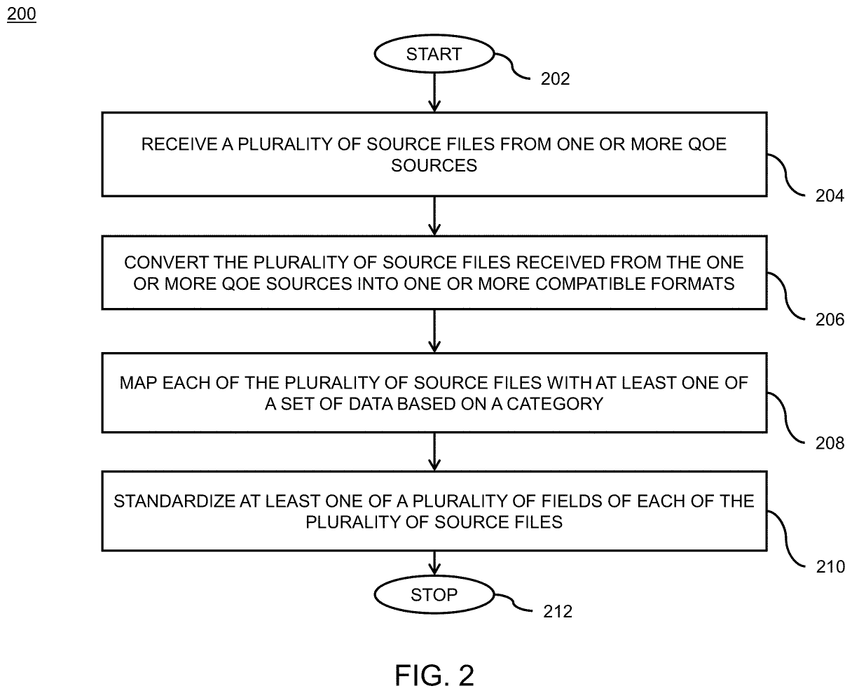

FIG. 2 illustrates a flowchart 200 to enable the plurality of users 102 to cross-reference different sources of the quality of telecom experience, in accordance with various embodiments of the present disclosure. It may be noted that in order to explain the method steps of the flowchart 200, references will be made to the elements explained in FIG. 1. The flowchart 200 starts at step 202. At step 204, the QoE database management system 110 receives the plurality of source files from the one or more QoE sources 108. At step 206, the QoE database management system 110 converts the plurality of source files received from the one or more QoE sources 108 into the one or more compatible formats. At step 208, the QoE database management system 110 maps each of the plurality of source files with the at least one of the set of data based on the category. At step 210, the QoE database management system 110 standardizes the at least one of the plurality of fields of each of the plurality of source files.

The flowchart 200 terminates at step 212. It may be noted that the flowchart 200 is explained to have above stated process steps; however, those skilled in the art would appreciate that the flowchart 200 may have more/less number of process steps which may enable all the above stated embodiments of the present disclosure.

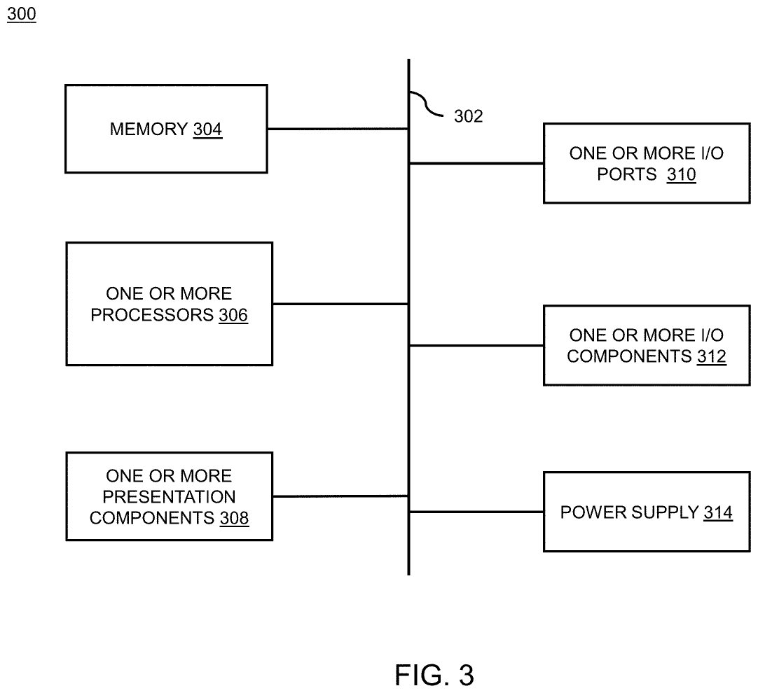

FIG. 3 illustrates the block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer readable storage media and communication media. The computer readable storage media includes volatile and nonvolatile, removable and non-removable media implemented in any method or technology for storage of information such as computer-readable instructions, data structures, program modules or other data.

The computer-readable storage media with memory 304 includes, but is not limited to, non-transitory computer readable media that stores program code and/or data for longer periods of time such as secondary or persistent long term storage, like RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300.

The computer-readable storage media associated with the memory 304 and/or other computer-readable media described herein can be considered computer readable storage media for example, or a tangible storage device. The communication media typically embodies computer-readable instructions, data structures, program modules or other data in a modulated data signal such as a carrier wave or other transport mechanism and in such a includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The computing device 300 includes one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to explain the principles of the present technology best and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for enabling a plurality of users to cross-reference different sources of quality of telecom experience, the computer-implemented method comprising:
receiving, at a QoE database management system with a processor, a plurality of source files from one or more QoE sources, wherein the plurality of source files is in one or more formats;
converting, at the QoE database management system with the processor, the plurality of source files received from the one or more QoE sources into one or more compatible formats, wherein the plurality of source files is converted into the one or more compatible formats in real-time;
mapping, at the QoE database management system with the processor, each of the plurality of source files with at least one of a set of data based on a category, wherein each of the plurality of source files is mapped with the at least one of the set of data in real-time; and
standardizing, at the QoE database management system with the processor, at least one of a plurality of fields of each of the plurality of source files, wherein the at least one of the plurality of fields is standardized to converge on a QoE database in real-time.

2. The computer-implemented method as recited in claim 1, wherein the one or more QoE sources comprise at least one of one or more telecom sources and one or more generic sources.

3. The computer-implemented method as recited in claim 1, wherein the one or more compatible formats comprise at least one of one or more text file formats, one or more spreadsheet file formats and one or more geographic file formats.

4. The computer-implemented method as recited in claim 1, wherein the category comprises at least one of measurement, antennas and point of interest.

5. The computer-implemented method as recited in claim 1, wherein the set of data comprises date, latitude, longitude, country, type of connection, a telecom operator, measures protocol and a plurality of key performance indicators for each protocol.

6. The computer-implemented method as recited in claim 1, further comprising enabling, at the QoE database management system with the processor, the plurality of users to specify a cell of at least one of the plurality of source files where corresponding data of the set of data is stored, wherein the plurality of users specifies the cell of the at least one of the plurality of source files in real-time.

7. The computer-implemented method as recited in claim 1, further comprising integrating, at the QoE database management system with the processor, content of each of the plurality of source files based on similarity in nature to same column of a table of the QoE database.

8. The computer-implemented method as recited in claim 1, further comprising comparing, at the QoE database management system with the processor, a value provided by the plurality of users to at least one of a plurality of values, wherein the plurality of values comprises international code of a telecom operator, internal code at the QoE database management system and commercial name of the telecom operator.

9. The computer-implemented method as recited in claim 1, wherein the plurality of fields comprises country, a telecom operator, type of connection, technology, device model, typical rental, measurement state and operating system.

10. A computer system comprising:
one or more processors; and
a memory coupled to the one or more processors, the memory for storing instructions which, when executed by the one or more processors, cause the one or more processors to perform a method for enabling a plurality of users to cross-reference different sources of quality of telecom experience, the method comprising:
receiving, at a QoE database management system, a plurality of source files from one or more QoE sources, wherein the plurality of source files is in one or more formats;
converting, at the QoE database management system, the plurality of source files received from the one or more QoE sources into one or more compatible formats, wherein the plurality of source files is converted into the one or more compatible formats in real-time;
mapping, at the QoE database management system, each of the plurality of source files with at least one of a set of data based on a category, wherein each of the plurality of source files is mapped with the at least one of the set of data in real-time; and
standardizing, at the QoE database management system, at least one of a plurality of fields of each of the plurality of source files, wherein the at least one of the plurality of fields is standardized to converge on a QoE database in real-time.

11. The computer system as recited in claim 10, wherein the one or more QoE sources comprise at least one of one or more telecom sources and one or more generic sources.

12. The computer system as recited in claim 10, wherein the one or more compatible formats comprise at least one of one or more text file formats, one or more spreadsheet file formats and one or more geographic file formats.

13. The computer system as recited in claim 10, wherein the category comprises at least one of measurement, antennas and point of interest.

14. The computer system as recited in claim 10, wherein the set of data comprises date, latitude, longitude, country, type of connection, a telecom operator, measures protocol and a plurality of key performance indicators for each protocol.

15. The computer system as recited in claim 10, further comprising enabling, at the QoE database management system, the plurality of users to specify a cell of at least one of the plurality of source files where corresponding data of the set of data is stored, wherein the plurality of users specifies the cell of the at least one of the plurality of source files in real-time.

16. The computer system as recited in claim 10, further comprising integrating, at the QoE database management system, content of each of the plurality of source files based on similarity in nature to same column of a table of the QoE database.

17. The computer system as recited in claim 10, further comprising comparing, at the QoE database management system, a value provided by the plurality of users to at least one of a plurality of values, wherein the plurality of values comprises international code of a telecom operator, internal code at the QoE database management system and commercial name of the telecom operator.

18. The computer system as recited in claim 10, wherein the plurality of fields comprises country, a telecom operator, type of connection, technology, device model, typical rental, measurement state and operating system.

19. A non-transitory computer-readable storage medium encoding computer executable instructions that, when executed by at least one processor, performs a method for enabling a plurality of users to cross-reference different sources of quality of telecom experience, the method comprising:
receiving, at a computing device, a plurality of source files from one or more QoE sources, wherein the plurality of source files is in one or more formats;
converting, at the computing device, the plurality of source files received from the one or more QoE sources into one or more compatible formats, wherein the plurality of source files is converted into the one or more compatible formats in real-time;
mapping, at the computing device, each of the plurality of source files with at least one of a set of data based on a category, wherein each of the plurality of source files is mapped with the at least one of the set of data in real-time; and
standardizing, at the computing device, at least one of a plurality of fields of each of the plurality of source files, wherein the at least one of the plurality of fields is standardized to converge on a QoE database in real-time.
